(19) United States
(12) Patent Application Publication
(10) Pub. No.: US 2026/0076509 A1
(43) Pub. Date: Mar. 19, 2026

(54) Devices, Systems, and Methods for Automated Food Frying

(71) Applicant: brd BOT Inc., Cupertino, CA (US)

(72) Inventors: Syed Saquib, Cupertino, CA (US); Ninaad Sridharan, Cupertino, CA (US); Nidhin Madhu, Cupertino, CA (US)

(21) Appl. No.: 19/330,629

(22) Filed: Sep. 16, 2025

Related U.S. Application Data
(60) Provisional application No. 63/694,989, filed on Sep. 16, 2024.

(51) Int. Cl. A47J 37/12; A47J 44/00

(52) U.S. Cl. CPC A47J 37/1228; A47J 37/1219; A47J 37/1242; A47J 37/1266; A47J 37/1295; A47J 44/00

(57) ABSTRACT

Described herein are various embodiments of systems, methods, and devices, for automated food frying. In one embodiment, systems, methods, and devices for automated food frying may comprise upon receiving an order of food, automatically transferring a designated amount of frozen food from a rotating tumbler in a freezer unit to a weighing unit upon receiving a specific weight of frozen food from the freezer unit; transferring, via the weighing unit, the frozen food to a fryer unit; cooking the frozen food in one or more rotatable fry baskets of the fryer unit; rotating the one or more rotatable fry baskets about an axis to flip the cooked food into a funnel; transferring the cooked food from the funnel to a cup from a cup dispensing unit; and moving, via the cup dispensing unit, the cup with cooked food to an exit port.

### CROSS REFERENCE TO RELATED APPLICATIONS

This application claims priority from U.S. Provisional Patent Application No. 63/694,989, filed on Sep. 16, 2024, the disclosure of which is hereby incorporated herein in its entirety by reference.

### FIELD OF THE DISCLOSURE

The present disclosure relates to advanced vending machines and devices, and more particularly, to devices, systems, and methods for automated food frying.

### BACKGROUND

While vending machines are widely available and well-established, their functionality remains largely limited to dispensing pre-packaged or pre-prepared food and beverages.

Although some machines have emerged with the ability to cook food on-site, they often suffer from inefficiencies in cooking speed, order processing, and overall throughput. These systems typically handle only one order at a time, making them difficult to scale or optimize for high-demand environments.

Moreover, existing cooking-enabled vending machines frequently require specialized technicians for maintenance and operation, which undermines their serviceability and increases operational costs. Their design often lacks integration with modern digital tools, making remote management, predictive maintenance, and user-friendly ordering systems difficult to implement.

Currently, there are no vending machines that combine the efficiency of traditional vending machine systems with the ability to autonomously cook and dispense food, while also being serviceable without specialized technical expertise, digitally connected for mobile and computing device integration, optimized for multi-order processing, and being safe and easy to clean.

This background information is provided to reveal information believed by the applicant to be of possible relevance. No admission is necessarily intended, nor should be construed, that any of the preceding information constitutes prior art or forms part of the general common knowledge in the relevant art.

### BRIEF SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for devices, systems, and methods for automated food frying that combine the efficiency of traditional vending machine systems with the ability to autonomously cook and dispense food, while also being serviceable without specialized technical expertise, digitally connected for mobile and computing device integration, optimized for multi-order processing, and being safe and easy to clean.

In accordance with one aspect, there is provided a device for automatically cooking and serving food, the device comprising: a freezer unit comprising a rotating tumbler configured to store the pre-cooked food and rotate about a first axis continuously; a weighing unit configured to, upon the device receiving an order for food, receive pre-cooked food from the rotating tumbler; a fryer unit comprising one or more fryers, each of the one or more fryers configured to receive the pre-cooked food in a rotatable fry basket from the weighing unit, wherein the rotatable fry basket is rotatable about a second axis that, at a first end of an axis of rotation, submerges the rotatable fry basket in the one or more fryers to prepare cooked food, and at a second end of the axis of rotation, flips the rotatable fry basket over a funnel; and a cup dispensing unit configured to receive the cooked food from the funnel into a cup and transfer the cup filled with the cooked food to an exit port.

In some embodiments, the rotating tumbler is accessible via a front face of the freezer unit to load the rotating tumbler with the pre-cooked food.

In some embodiments, the rotating tumbler comprises: a hatch configured to receive the pre-cooked food from a source external to the device; and an exit hole configured to release a specific quantity of the pre-cooked food to the weighing unit.

In some embodiments, the exit hole comprises an adjustable guard, the adjustable guard being slidable along the exit hole for controlling the specific quantity of the pre-cooked food released from the rotating tumbler.

In some embodiments, the device further comprises a translation unit housing a dispensing corkscrew configured to rotate about a third axis and transfer the pre-cooked food from the rotating tumbler to the weighing unit.

In some embodiments, the weighing unit further comprises: a release claw configured to receive the pre-cooked food from the translation unit; and a load cell configured to determine a measured weight of the pre-cooked food in the release claw and compare the measured weight with a predefined weight of the pre-cooked food, wherein the release claw and the load cell are operatively coupled.

In some embodiments, the release claw is configured to release the pre-cooked food into the fryer unit upon the load cell determining that the predefined weight of the pre-cooked food is reached.

In some embodiments, the one or more fryers comprise cooking oil and a temperature controller.

In some embodiments, the temperature controller is configured to: keep the cooking oil at a standby temperature below a predefined cooking temperature while in a passive state; and increase the standby temperature to meet the predefined cooking temperature while in an active state, the active state triggered upon the device receiving the order for food.

In some embodiments, the cup dispensing unit comprises: a cup dispenser for holding a plurality of cups; a cup holder configured for receiving the cup from the plurality of cups; a first slide rail configured to translate the cup in a first direction to receive cooked food from the one or more fryers and subsequently translate the cup in a second direction; a second slide rail configured to translate the cup in a third direction towards the exit port; and a transfer interface between the first slide rail and the second slide rail, configured to translate the cup from the first slide rail to the second slide rail.

In some embodiments, the device further comprises one or more pumps configured to facilitate oil exchange between one or more oil storage units and the one or more fryers.

In accordance with another aspect, there is provided a method for automatically cooking and serving food, the method comprising: transferring pre-cooked food from a rotating tumbler in a freezer unit to a weighing unit upon receiving an order of food, wherein the rotating tumbler is configured to store the pre-cooked food and rotate about a first axis continuously; transferring, via the weighing unit, the pre-cooked food received in the weighing unit from the rotating tumbler to a rotatable fry basket in each of the one or more fryers in a fryer unit, wherein the rotatable fry basket rotates about a second axis; cooking, via the fryer unit, the pre-cooked food in the rotatable fry basket by submerging the rotatable fry basket in the one or more fryers at a first end of an axis of rotation; transferring, via the fryer unit, cooked food from the one or more fryers to a funnel by flipping the rotatable fry basket over the funnel at a second end of the axis of rotation; transferring, via a cup dispensing unit, the cooked food from the funnel to a cup; and transferring, via the cup dispensing unit, the cup filled with the cooked food to an exit port.

In some embodiments, the method further comprises accessing the rotating tumbler via a front face of the freezer unit to load the rotating tumbler with the pre-cooked food.

In some embodiments, the method further comprises: filling the rotating tumbler with the pre-cooked food from a source external to the device via a hatch on the rotating tumbler; and releasing a specific quantity of the pre-cooked food from the rotating tumbler to the weighing unit via an exit hole on the rotating tumbler.

In some embodiments, the method further comprises adjusting an adjustable guard along the exit hole for controlling a specific quantity of the pre-cooked food to be released from the rotating tumbler.

In some embodiments, the method further comprises an intermediate step of transferring the pre-cooked food from the rotating tumbler to a translation unit before transferring the pre-cooked food from the translation unit to the weighing unit.

In some embodiments, the translation unit houses a dispensing corkscrew configured to rotate about a third axis and transfer the pre-cooked food from the freezer unit to the weighing unit.

In some embodiments, the method further comprises: receiving, via a release claw of the weighing unit, the pre-cooked food from the translation unit; determining, via a load cell of the weighing unit, a measured weight of the pre-cooked food on the release claw, wherein the release claw and load cell are operatively coupled; and comparing, via the load cell of the weighing unit, the measured weight with a predefined weight of the pre-cooked food.

In some embodiments, the method further comprises releasing the pre-cooked food from the release claw to the one or more fryers upon the load cell determining that the predefined weight of the pre-cooked food is reached.

In some embodiments, the method further comprises controlling, via a temperature controller on the frying unit, temperature of cooking oil within the one or more fryers, wherein the temperature controller is configured to: keep the cooking oil at a standby temperature below a predefined cooking temperature while in a passive state; and increase the standby temperature to meet the predefined cooking temperature while in an active state, the active state triggered upon the device receiving the order for food.

Other aspects, features and/or advantages will become more apparent upon reading of the following non-restrictive description of specific embodiments thereof, given by way of example only with reference to the accompanying drawings.

### BRIEF DESCRIPTION OF THE DRAWINGS

Several embodiments of the present disclosure will be provided, by way of examples only, with reference to the appended drawings, wherein:

FIG. 1A illustrates a perspective view showing a front portion of an automatic food cooking device in its closed configuration, in accordance with one embodiment;

FIG. 1B illustrates a perspective view showing a back portion of an automatic food cooking device in its closed configuration, in accordance with one embodiment;

FIG. 2 illustrates a perspective view of an automatic food cooking device in its open configuration, in accordance with one embodiment;

FIG. 3 illustrates an exploded view of the plurality of internal components of an automatic food cooking device, in accordance with one embodiment;

FIG. 4 illustrates a perspective view of a freezer unit and part of a translation unit of an automatic food cooking device, in accordance with one embodiment;

FIG. 5 illustrates an exploded view of components of a freezer unit of an automatic food cooking device, in accordance with one embodiment;

FIG. 6A illustrates an exploded view of a translation unit of an automatic food cooking device, in accordance with one embodiment;

FIG. 6B illustrates a perspective view of a dispensing corkscrew module; in accordance with one embodiment;

FIG. 6C illustrates a perspective view of a corkscrew used in a dispensing corkscrew module; in accordance with one embodiment;

FIG. 7A illustrates an exploded view of a fry basket assembly of an automatic food cooking device, in accordance with one embodiment;

FIG. 7B illustrates a perspective view of a fry basket assembly of an automatic food cooking device, in accordance with one embodiment;

FIG. 7C illustrates a perspective view of a mesh basket in one or more fryers of an automatic food cooking device, in accordance with one embodiment.

FIG. 8 illustrates an exploded view of a weighing unit of an automatic food cooking device, in accordance with one embodiment;

FIG. 9A illustrates an exploded view of a cup dispensing unit of an automatic food cooking device, in accordance with one embodiment;

FIG. 9B illustrates a perspective view of a cup dispensing unit of an automatic food cooking device, in accordance with one embodiment; and

FIG. 10 illustrates an exploded view of an extended portion of a front face of an automatic food cooking device, in accordance with one embodiment.

Elements in the several drawings are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of. ” The phrase “one or more of the following: A, B, and C” means “at least one of A and/or at least one of B and/or at least one of C.”

The systems, methods, and devices described herein deliver fully automated, end-to-end food preparation. Unlike existing systems, this configuration would combine high-efficiency operation with robust serviceability, eliminating the need for specialized technicians while enabling seamless integration with digital platforms for ordering, maintenance, and performance optimization. Different aspects of the disclosure are also intentionally configured to be compliant with food handling and safety regulations.

It would be evident to one skilled in the art that the systems, methods, and devices described herein may be used for automated frying of all manner of foods. The systems, methods, and devices described herein are also particularly well-suited for automated frying of pre-cooked, flash frozen foods, which may include, but is not limited to, chicken wings or nuggets, fish sticks, French fries, imitation meat, and the like. The present disclosure further provides methods of configuring and maintaining the devices.

For the purposes of this disclosure, “automatically” may generally be interpreted as “robotically” as in, food is translated from step to step automatically, via a series of connected systems/robots that trigger one another to perform each step. When an order is prepared automatically, by the devices and methods of the present disclosure, it does so upon receiving an order, which triggers the device to perform the steps of the method as discussed below. Preparing an order may take some time. However, none of the steps require human intervention once the order is placed by a user or customer.

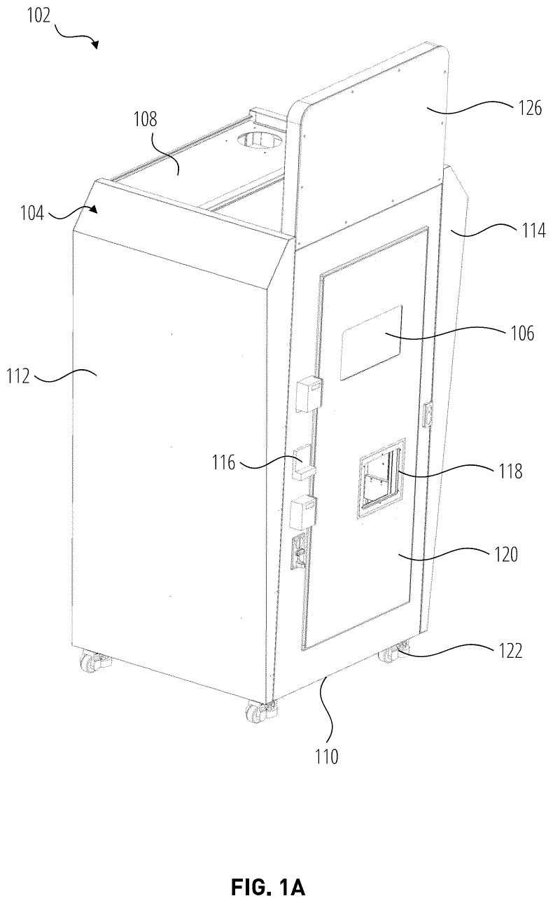

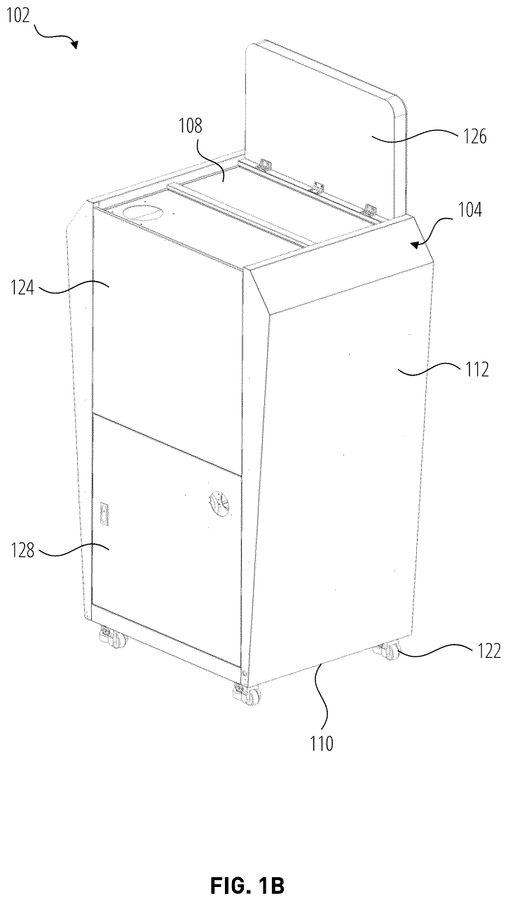

FIG. 1A and FIG. 1B illustrate perspective views of an automatic food cooking device 102 in its closed configuration, in accordance with one embodiment. The automatic food cooking device 102 comprises an external body 104 housing a plurality of internal components, wherein the external body 104 comprises one or more doors 120 configured for accessing the plurality of internal components. The one or more doors 120 may comprise one or more locks for security. The device 102 generally has a rectangular prism shape with the following dimensions (H×W×D): 7 feet×2.7 feet×3.7 feet.

The automatic food cooking device 102 has a top end, a bottom end, a left end, a right end, a rear end, and a front end directly opposite the rear end. As described herein, the left end and right end are referenced from a front-facing perspective of the device 102. The external body 104 generally has a rectangular prism shape and may comprise a plurality of faces, including a front face 114, back face 124, top face 108, bottom face 110, left side face 112, and right side face (not shown). In some embodiments, the top end may be wider than the bottom end of the device 102. Edges of the left side face 112 and right side face may be beveled with respect to the top face 108. In some embodiments, the front face 114 may extend higher than the level of the top face 108. The extended portion 126 of the front face 114 may also be decoupled from the rest of the front face 114 when the door 120 of the front face 114 is opened. In some embodiments, the extended portion 126 may be in a form of a lightbox signage to display a brand, logo or other offerings. In some embodiments, the bottom face 110 may be connected to one or more support legs 122 configured to lift and stabilize the device 102. The support legs 122 may include wheels for ease of transport from one location to another.

In some embodiments, the front face 114 comprises a display screen 106 for ordering, a payment system 116 for making payments, and an exit port 118, where cooked food is delivered to a user or customer after being cooked inside the device 102. The front face 114 of the automatic food cooking device 102 is the customer-facing side. The display screen 106 may be a touch screen on a tablet. The display screen 106 may also be used by administrators to view food stock within the device 102 and configure other system settings through this interface. In order to maximize orders per hour, the device 102 may utilize a queue system that allows users to continuously order without waiting for the prior order to complete. In the queue system, each new order is added to the queue and processed when the one or more fryers 310 become available for the order. The payment system 116 may comprise a card reader, cash acceptor or QR code. Accepted means of payment may include payments via physical cards, cash, digital wallets (e.g., Apple Pay, Google Pay, Samsung Pay) or other payment means known in the art.

In some embodiments, the exit port 118 may comprise a cover that may be operatively coupled with an actuator (e.g. DC motor) to move the cover from its closed state to an open state, allowing the user or customer to retrieve the cooked food. The cover may also be moved from the open state to the closed state by the actuator once the cooked food is retrieved. In some embodiments, the exit port 118 may be adapted to hold more than one order at a time. Furthermore, the exit port 118 may be equipped with a password or QR code mechanism, requiring users or customers to either enter a designated password or scan a QR code to verify and access their specific order, thereby preventing unauthorized retrieval of orders belonging to other users or customers. In some embodiments, orders may be held at the exit port 118 for a pre-set time (e.g., 3 minutes) before an alarm sound notifies a local manager to pick up the order and place it on the side or other designated location. The exit port 118 may also be equipped with a warming oven, which may comprise a simple heat lamp or oven, which may keep orders warm until they are picked up either by the user, customer, or a manager in the event of the order being left behind.

The user or customer may order food, which will then be cooked by the device 102, either via a display screen 106 on the device 102 directly, or via a website or app on a computing device or mobile device, which is communicatively coupled with the device 102 via a wired or wireless internet connection, for example. The user or customer will interact with the device 102 by selecting their order through the display screen 106. After selecting their order, the user or customer will pay through the payment system 116. Upon receiving the order for food and corresponding payment from the user or customer, the device 102 automatically cooks the order of food and dispenses the cooked food to the user or customer through the exit port 118.

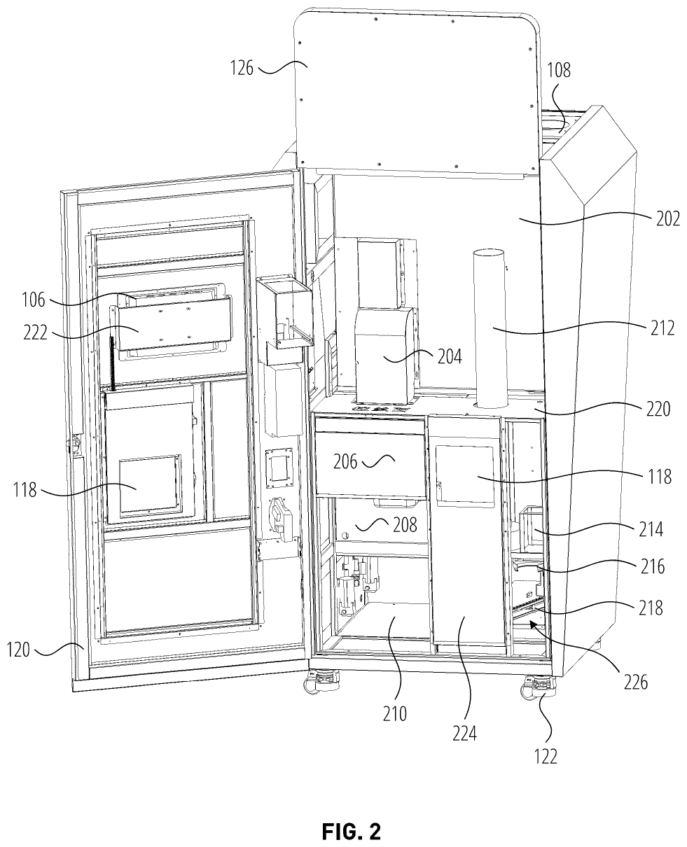

Both the front face 114 and the back face 124 may each comprise a door 120 that, when opened by maintenance personnel, give access to the interior of the device 102 (shown in FIG. 2) for cleaning, inspecting, and restocking the device 102. The top face 108 or the top portion of the front face 114 may also comprise a door 120 to access a freezer unit.

In some embodiments, the specifications of the illustrated device 102 are as follows: Power Consumption (Peak): 3.7 kW; Power Consumption (Standby): 1 kW; and Freezer Temperature Range (°C): 10 to −26. Of course, as anyone skilled in the art would readily appreciate, the aforementioned specifications, as well as the specific materials described below, may be modified without deviating from the scope of this disclosure.

FIG. 2 illustrates a perspective view of an automatic food cooking device 102 its open configuration, in accordance with one embodiment. The door 120 is opened in the illustrated figure to view the plurality of internal components within the device 102. The door 120 may be connected to the body of the device 102 through one or more hinges that may be placed on either side of the front face 114 of the device 102.

The plurality of internal components of the automatic food cooking device 102 comprise a freezer unit 202, translation unit 204, weighing unit 206, fryer unit 208, funnel 214, oil exchange unit 210, and cup dispensing unit 226. In some embodiments, the freezer unit 202 is positioned at the top-rear end of the device 102. The translation unit 204 is positioned at the front-left portion of the freezer unit 202, wherein the translation unit 204 is operatively coupled with the freezer unit 202. The weighing unit 206 is positioned directly under the translation unit 204 and the left portion of the freezer unit 202, wherein the weighing unit 206 generally spans across the depth of the device 102. The fryer unit 208 is at the left-rear end of the device 102, situated directly underneath the rear end of the weighing unit 206. The funnel 214 is positioned at the right-rear end of the device 102 beside the fryer unit 208. The oil exchange unit 210 is positioned under the fryer unit 208 at the left-rear end of the device 102. The cup dispensing unit 226 is positioned at the right-bottom end and generally spans across the depth of the device 102. The aforementioned positional references to the plurality of internal components are based on a standard orientation of a preferred embodiment of the device 102, wherein the position of each unit is determined by the functional architecture of the device 102. Other embodiments of the device 102 may have variations in the positions of the plurality of internal components. For instance, in order to maintain the low temperature of the freezer unit 202 and high temperature of the fryer unit 208, the freezer unit 202 may be housed at the top-front end of the device 102, while the fryer unit 208 may be housed towards the bottom-rear end of the device 102. The positions of the freezer unit 202 and the fryer unit 208 in a tightly enclosed space such as that of the automatic food cooking device 102 have been designed not only to ensure that appropriate temperatures are maintained, but also to ensure that food health and safety standards are met.

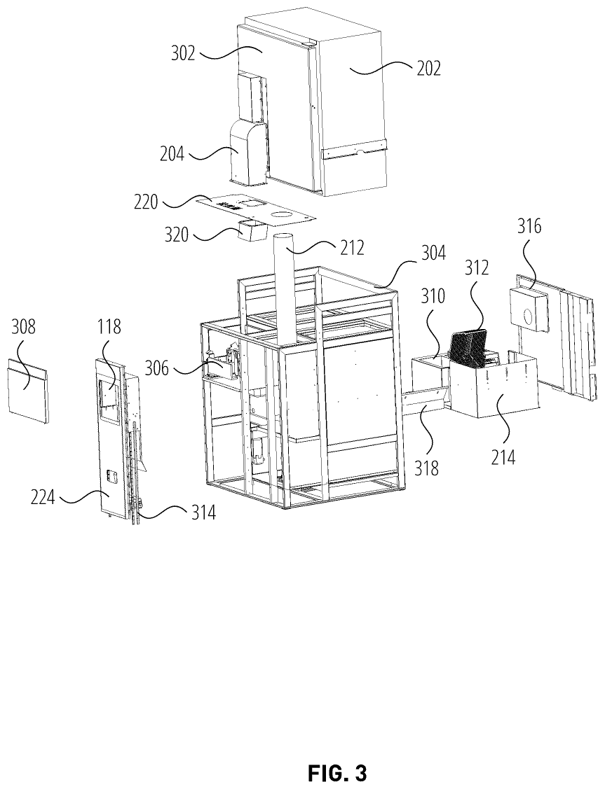

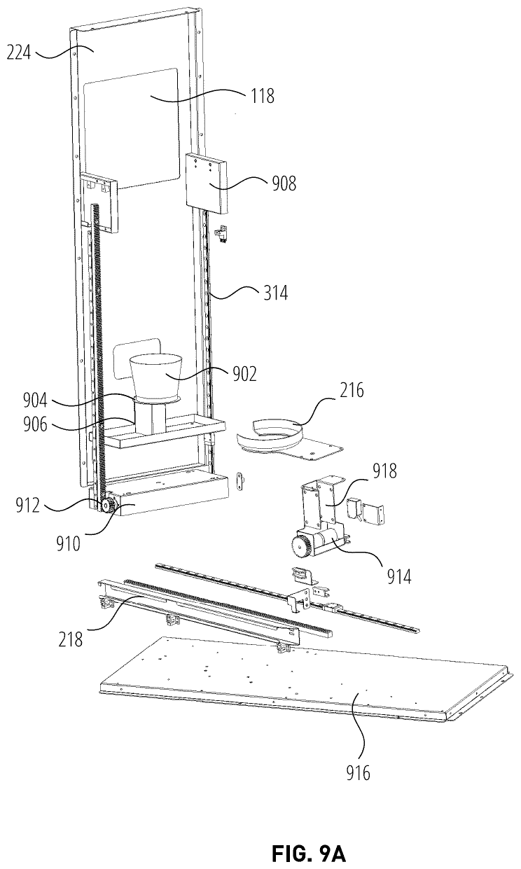

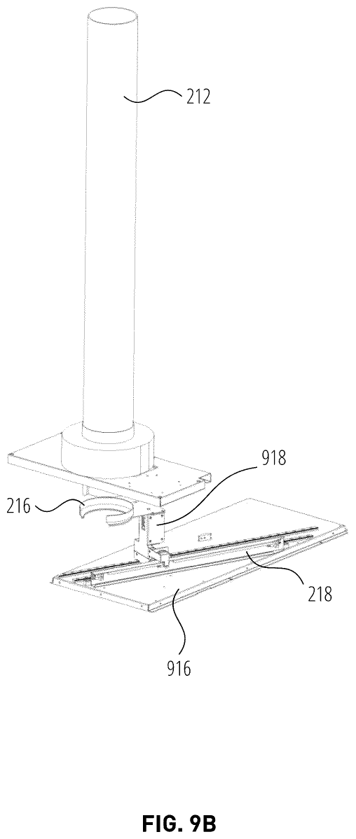

As shown in FIG. 2, the back side of the door 120 comprises elements corresponding to those shown in FIG. 1A. For instance, the back portion of the display screen 106 and a mounting bracket 222 to secure the display screen 106 on the door 120 are shown. The assembly of the display screen 106 and the mounting bracket 222 are generally placed across the freezer unit 202. The exit port 118 may have a square or rectangular configuration. The exit port 118 on the door 120 further aligns with the exit port 118 on an internal motorized door 224, wherein the internal motorized door is configured to serve as a structural mounting surface for a vertical lift (shown in FIG. 3 and FIG. 9A). The back side of the payment system 116 is also shown on the door 120.

In some embodiments, the freezer unit 202 has a recessed portion that houses the translation unit 204. The upper half of the device 102 comprises the freezer unit 202, the translation unit 204, and a large segment of a cup dispenser 212. In some embodiments, the cup dispenser is made of a plastic cylindrical tube that passes through a base plate 220 perpendicularly. The cup dispenser 212 may store a stack of a plurality of cups or containers configured to hold an order of cooked food. The plurality of cups or containers may be disposable. In some embodiments, the cup dispenser may store approximately 200 disposable cups. The base plate 220 separates the freezer unit 202 and translation unit 204 assembly with other units positioned in the lower half of the device 102. There are designated cutouts within the base plate 220, wherein a first cutout allows for passage of food from the translation unit 204 to the weighing unit 206 and a second cutout accommodates the cup dispenser 212.

Furthermore, the oil exchange unit 210 is configured to house a pump (not shown) and one or more oil storage containers, wherein at least one oil storage container contains clean cooking oil and at least one other oil storage container contains used cooking oil from the fryer unit 208. There is a vertical opening along the bottom-right side of the device 102 showing a funnel 214, c-shaped cup holder 216, and linear cup track 218. Components of each of the freezer unit 202, translation unit 204, weighing unit 206, fryer unit 208 and cup dispensing unit 226 and the mechanism in which these units interact with each other will become more evident in the following paragraphs.

FIG. 3 illustrates an exploded view of the plurality of internal components of an automatic food cooking device 102, in accordance with one embodiment. The freezer unit 202 may comprise an access panel 302 to clean, inspect, or restock the freezer unit 202 with frozen food. In some embodiments, the access panel 302 may be configured to be placed in front or at the top of the freezer unit 202, wherein the access panel 302 may be a sliding door or a hinged door. The translation unit 204 is further coupled with the access panel 302. Underneath the base plate 220 is a chute 320 which acts as a channel to deliver the frozen food from the translation unit 204 to the weighing unit 206. A cover plate 308 of the weighing unit 206 is removed to view a partial portion of it. The weighing unit 206 comprises a load cell 306 configured to determine the weight of the frozen food released from the freezer unit 202. The vertical lift 314 is mounted behind the internal motorized door 224 to deliver a cup filled with cooked food to the exit port 118. A frame 304 further provides structure to the plurality of internal components within the lower half of the device 102.

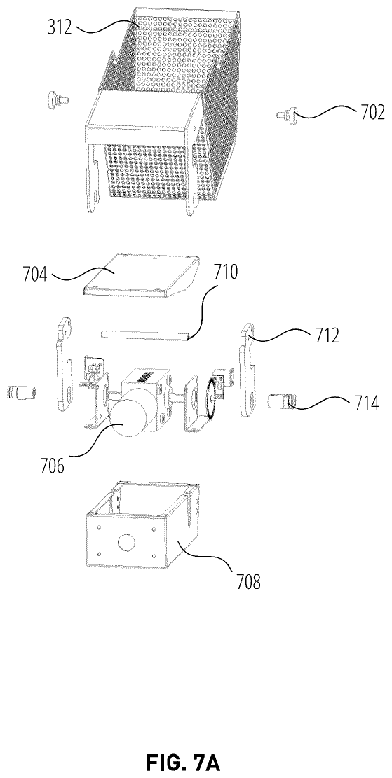

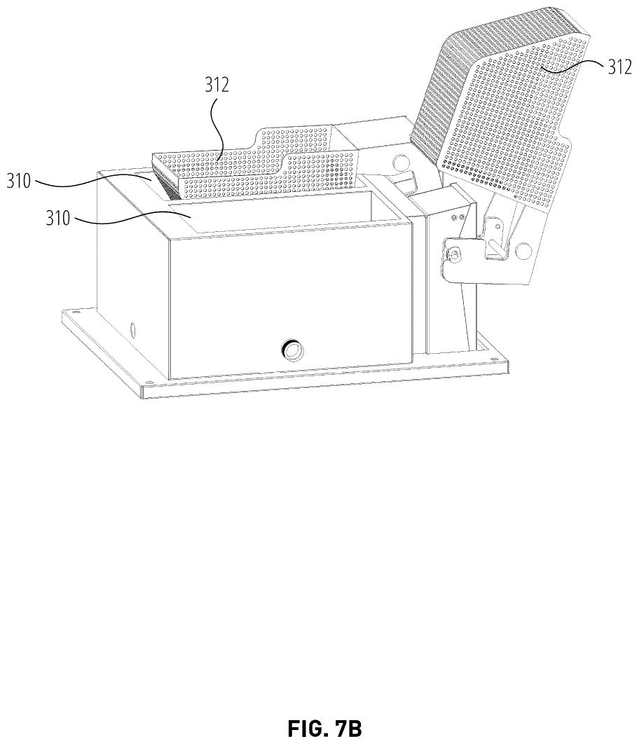

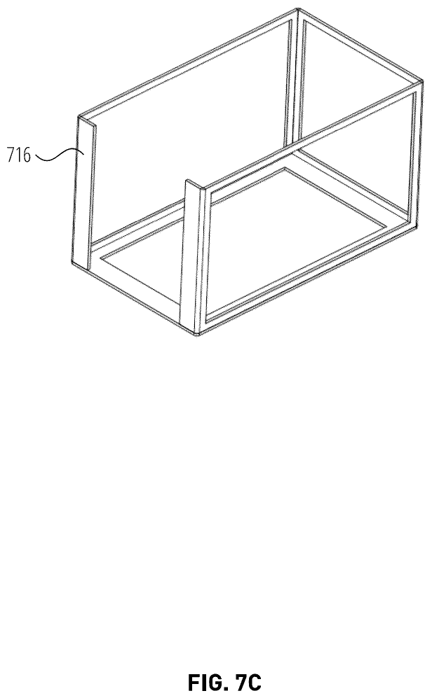

Positioned at the rear end of the device 102 is the fryer unit 208. The fryer unit 208 comprises a burner unit (not shown), one or more powered fry baskets 312, and one or more fryers 310, wherein each of the one or more fryers are lined with a mesh basket 716 (shown in FIG. 7C) configured to catch food debris while frying. A perspective view of the of a fry basket assembly of an automatic food cooking device 102, in accordance with one embodiment, is further shown in FIG. 7B. A custom optocoupler circuit board or optocoupler printed circuit board array (PCBA) may be built into each of the one or more fryers 310 to relay fryer state information and/or turn on and turn off the burner unit. The optocoupler circuit board may be further configured to interpret state data from red and green LED lights built into the burner unit. State data may include, but is not limited to, parameters such as power status, burner operational state (e.g., active/inactive), and other system-level indicators. The red LED light indicates that electrical power is supplied to the fryer unit 208, while the green LED light indicates activation of the burner unit. Together, these indicators provide visual confirmation of whether the fryer unit 208 is actively engaged in the heating oil within the one or more fryers 310. In some embodiments, the fryer unit 208 may alternatively be replaced, or used in conjunction with, any one or more of the following cooking units: a convection oven, air fryer, slow cooker, pressure cooker, steamer, microwave, and the like.

Depending on the size of the one or more fryers 310 or the size of the device 102, any number of fryers 310 could be accommodated for. The one or more fryers 310 have independent basins for oil and a thermostat (not shown) for temperature control. The thermostat may go up to a temperature of 200° C. and may use a high temperature limit (via a wattage limit) switch to shut off the fryers 310 in the case of a current or temperature spike. The thermostat may also be digital or analog. In some embodiments, the thermostat in each of the one or more fryers 310 may have a dial that can be adjusted to set a steady state temperature. There may also be limiters configured to automatically shut off each of the one or more fryers 310 if no oil is detected in the basin. The limiters prevent overheating and reduce the risk of equipment damage or fire hazards. In some embodiments, the one or more fryers 310 may be used for cooking different foods. The one or more fryers 310 may be operated concurrently or individually, contingent upon the quantity of orders received on the device 102.

In some embodiments, the fryer unit 208 may comprise a real-time, live temperature sensor that continuously monitors oil temperature, and allows the burner unit to be turned on or off at any given temperature in order to speed up the rate of ordering. Preferably, but not necessarily, the oil in the one or more fryers 310 is kept at a standby temperature when the one or more fryers 310 are in a passive state, wherein standby temperature is defined as a steady, but elevated temperature, below the preferred frying temperature (e.g., <160° C), and the passive state of the one or more fryers 310 refers to an operational state in which the one or more fryers 310 are powered on, but are not actively cooking food. When the one or more fryers 310 are about to be used (e.g., when a user or customer places an order on the device 102), the one or more fryers 310 move from the passive state to an active state, wherein the active state of the one or more fryers 310 refers to an operational state in which the one or more fryers 310 are in an active cooking mode. In the active state, the temperature of the oil (i.e., standby temperature) in the one or more fryers 310 is ramped up efficiently to an optimal frying temperature (typically 160° C-180° C. or 325° F.-375° F). This custom thermal management feature allows the oil to be kept just below cooking temperature to minimize the rate of oil degradation, while maximizing readiness and order fulfillment efficiency. Cooking time of the frozen food in the one or more fryers 310 may be based on a predefined time based on food type or a predefined temperature of the food measured by the temperature sensor. Once the frozen food is cooked, the one or more fryers 310 move from the active state to the passive state until another order is placed by a user or customer.

Furthermore, the one or more fryers 310 are further configured to each receive a powered fry basket 312. The powered fry baskets 312 are configured to be made of food safe and heat-resistant materials to withstand high temperatures and constructed with a perforated metal grid. Having the perforated metal grid allows for even cooking when submerged in oil within the one or more fryers 310 and ease of removal of the cooked food from the one or more fryers 310. In some embodiments, the powered fry baskets 312 are mounted on a rotary actuator. The powered fry baskets 312 may comprise a pivot point along a shaft driven by a rotary actuator, which enables the powered fry baskets 312 to follow an arc-shaped path to displace and deliver cooked food from the one or more fryers 310 to the funnel 214 and into a cup in the cup dispensing unit 226. In some embodiments, the rotary actuator may further comprise a DC motor and a worm gearbox that produces the rotational motion of the powered fry baskets 312. Precise position and angle control may be obtained by a break beam pinwheel with slits every 10 degrees.

In some embodiments, the funnel 214 is configured to have a tapered design to direct the cooked food into the cup. In some embodiments, the funnel 214 may have a round, square or rectangular cross-section. The funnel 214 may be made from stainless steel or other food safe and heat-resistant materials known in the art. The funnel 214 may also have a shield extending upwards from the inlet portion to manage any oil splatter or droplets. In addition, an oil drip tray 318 is positioned underneath the central portion of the powered fry baskets 312 to catch any excess oil when the powered fry baskets 312 deliver the cooked food from the one or more fryers 310 to the funnel 214.

In some embodiments, the fryer unit 208 may simultaneously process more than one order, each in the one or more fryers 310. After a first order of food is finished frying, a first fry basket will proceed with the aforementioned process to deliver the cooked food from a first fryer to the funnel 214 by the rotation of the first fry basket. Frying of a second order of food may simultaneously be completed. In this case, a second fry basket will transiently move up to a point just above the oil in a second fryer and hold the order until the previous order has been placed in a cup and served to the customer. The fryer unit 208 then waits for a new cup to be dispensed from the cup dispenser 212 into the c-shaped cup holder 216, wherein the cup arrives underneath the funnel 214 via the linear cup track 218 before the cooked food from the second fryer is delivered through the funnel 214 and into the new cup.

Behind the one or more fryers 310, fry basket 312 and funnel 214 is a fryer unit door 316 that can only be accessed by authorized personnel or operators. The authorized personnel or operators may require one or more keys to access the fryer unit door. Once the fryer unit door 316 is opened, the authorized personnel or operators may perform maintenance activities such as inspecting, refilling, emptying, and cleaning the fryer unit 208. The fryer unit door 316 may also serve to seal the fryer unit 208 from the remainder of the device 102, particularly the electronics of the device 102. In some embodiments, the fryer unit door is coupled with a larger maintenance panel at the bottom-rear end of the device 102 that extends to cover the oil exchange unit 210, allowing the authorized personnel or operators to refill, empty and/or replace the one or more oil storage containers in the oil exchange unit 210. The fryer unit door 316 may also be used for other servicing or troubleshooting purposes. Some safety measures of the device 102 may include, but are not limited to, the isolation of the fryer unit 208 from any electronics by having a safety panel and having a fire suppression device included in the fryer unit 208.

In some embodiments, the fryer suppression device may comprise any fire suppression device known in the art including, but not limited to, commercially available class K fire suppression devices which are designed for use in fat or cooking oil fires, or one suitable for all of class A, B, C, and K fires. The fire suppression device may be mounted in the fryer unit 208 and configured to automatically activate if a fire ignites or if the ambient temperature in the fryer unit 208 exceeds a pre-determined temperature (e.g., 338° F. or 170° C.). Preferably, the fire suppression device is mounted near the one or more fryers 310, but is not in contact with any food.

Grease laden vapors are produced when heat and steam rise from a cooking surface that contains grease. The passage of grease laden vapors through the ventilation system results in deposits on the interior surfaces. A severe fire hazard exists if the accumulated grease within the ventilation system is not removed. Therefore, to mitigate this challenge, the fryer unit 208 may further comprise an exhaust fan, which itself uses an activated carbon filter to remove particulates. The carbon filter may be a commercially available filter, and may capture more than 95% of grease-laden vapor, odor, and particulates caused from cooking.

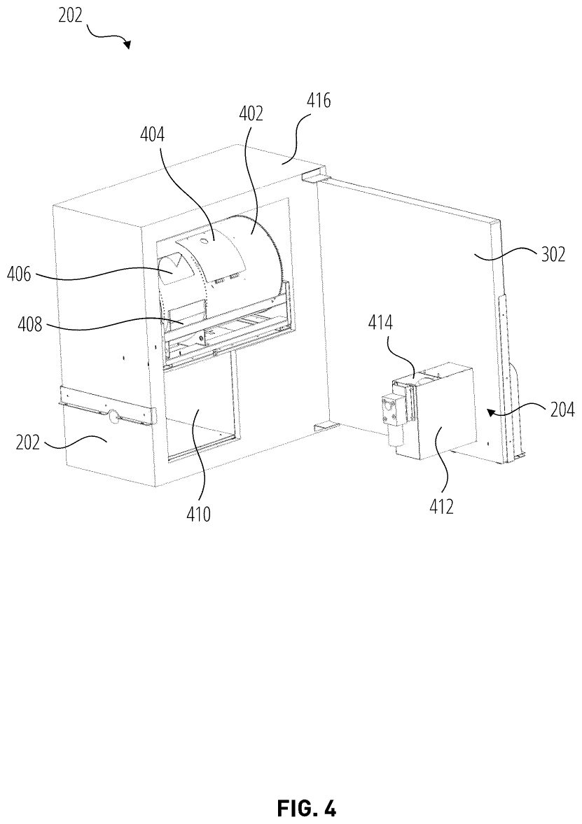

FIG. 4 illustrates a perspective view of a freezer unit 202 and part of a translation unit 204 of an automatic food cooking device 102, in accordance with one embodiment. The freezer unit 202 is preferably designed to maintain pre-cooked, flash-frozen food in a frozen state until they are ready to be transferred for frying. In terms of food safety, the pre-cooked, flash-frozen food may be ordered from reputable distributors and is ensured to be handled with care to avoid contamination.

The freezer unit 202 mainly comprises a tumbler 402 while the translation unit 204 mainly comprises a dispensing corkscrew module 412. The freezer unit 202 may be enclosed by insulated housing 416 that has an access panel 302. In some embodiments, the tumbler 402 is positioned across the length of the upper portion of the freezer unit 202, while the dispensing corkscrew module 412 is positioned directly beneath the tumbler 402 when the access panel 302 is closed since the dispensing corkscrew module 412 is configured to fit within a dispensing corkscrew module compartment 410. The dispensing corkscrew module 412 may be directly coupled with the access panel 302 of the freezer unit 202 for ease of maintenance. The tumbler 402 may also be referred to as a hopper.

The tumbler 402 may be a cylinder configured to periodically rotate or spin about a horizontal axis to prevent the frozen food from clumping together. The tumbler may be supported by one or more supporting structures such as a drum guard 408. The tumbler 402 may further be made out of metal such as bent stainless steel sheets. Other materials known in the art to be food safe and resilient at low temperatures may be used to form the tumbler 402. On one side of the tumbler 402 is a hatch 404 that acts as an access point for refilling or restocking the tumbler 402 with frozen food. On another side of the tumbler 402 is a corkscrew exit hole 406 configured to release a designated amount of frozen food into a slot 414 in the dispensing corkscrew module 412.

In some embodiments, the capacity of the rotating tumbler 402 may be 4.71 cubic feet. In some embodiments, about 30 lbs to 40 lbs of chicken, French fries, or other frozen foods may be loaded (manually or via an automated process), into the hatch 404 of the tumbler 402 which uses a quick release latch to open. The amount of frozen food that can be loaded into the tumbler 402 may vary in other embodiments.

In some embodiments, the freezer unit 202 may comprise a thermostat and temperature probe (both not shown) as double redundancy to ensure the food always stays under 32° F. or 0° C. The thermostat locally monitors and controls a feedback loop in the freezer unit 202, and the temperature probe sends data back to a machine controller unit (not shown) in order to lock out ordering if the temperature rises above 32° F. or 0° C. The thermostat may also be digital or analog. In some embodiments, the thermostat may have a dial to adjust the temperature for any type of food housed within the freezer unit 202. The temperature range of the freezer unit 202 may be limited to 10° C. to −26° C.

In order to help keep temperatures of the freezer unit 202 and the fryer unit 208, the freezer unit 202 preferably comprises insulation, both in the freezer unit 202 itself, and by its housing. Further, the freezer unit 202 and the fryer unit 208 are preferably housed generally remotely from one another. The freezer unit 202 may also comprise an alarm which notifies an operator of power loss or temperature spike, at which point the operator would dispose of any remaining food, and perform maintenance on the device 102.

In alternative embodiments, the freezer unit 202 may be replaced, or used in conjunction with, other food storage methods, depending on the desired temperature of the stored food. This may include, but is not limited to, dry storage for canned items or bread or refrigerators for non-frozen perishables or pre-prepared food. In terms of maintenance, the tumbler 204 may be removed by a hex key, or other similar tools known in the art (i.e., a screwdriver or drill).

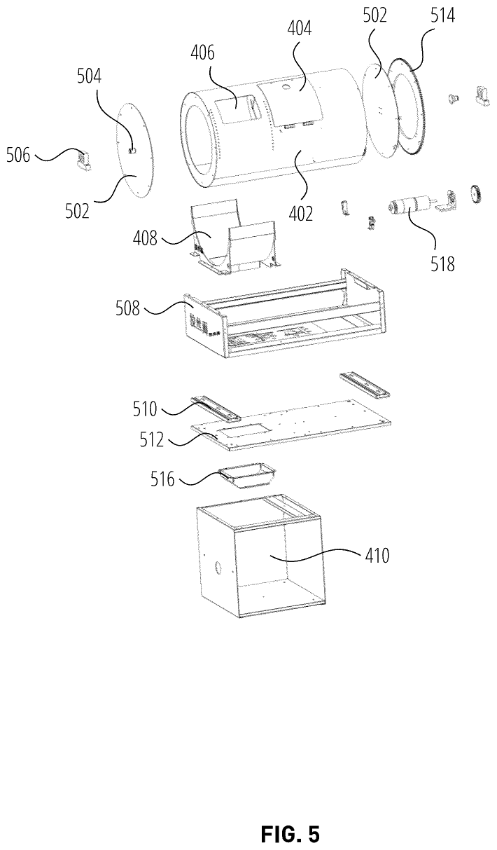

FIG. 5 illustrates an exploded view of components of a freezer unit 202 of an automatic food cooking device 102, in accordance with one embodiment. The freezer unit 202 comprises an assembly of a plurality of components, mainly comprising a tumbler 402 and a plurality of supporting structures configured to secure the tumbler in place and provide a channel for frozen food to be moved to the dispensing corkscrew module 412.

The tumbler 402 may be a cylinder comprising a main body with a hatch 404 and a corkscrew exit hole 406. Each side of the tumbler 402 has a disk plate 502 with a trunnion 504 coupled with a ball bearing block 506, allowing the tumbler 402 to be rotated about a horizontal axis via a tumbler motor 518 (e.g., DC motor). The disk plates make up the each of the side faces of the tumbler 402. The bearing blocks 506 allow the tumbler 402 to rest on a metal carriage. Any motor known in the art may be used for rotating the tumbler 402. In addition, break beams may be mounted to the sides of the tumbler 402 configured to track tumbler rotation. In some embodiments, there may be an additional supporting circular plate 514 on at least one side of the tumbler 402. Although not shown, the inner diameter of the tumbler 402 may comprise guiding plates that funnel the frozen food towards the corkscrew exit hole 406.

In some embodiments, the corkscrew exit hole 406 comprises an adjustable guard (not shown) which may slide forwards or backwards along the corkscrew exit hole 406 in order to control the amount of frozen food dropped into the slot 414 of the dispensing corkscrew module 412, which will eventually be dispensed for cooking in the fryer unit 208.

Some of the plurality of supporting structures may comprise a drum guard 408, a drum tray 508, supporting slide rails 510, a guide panel 512, a chute 516 and a dispensing corkscrew module compartment 410. Each of the plurality of supporting structures are configured to have a hole that aligns with the corkscrew exit hole 406 of the tumbler 402 and the slot 414 of the dispensing corkscrew module 412, allowing frozen food from the tumbler 402 to seamlessly enter the translation unit 204.

In some embodiments, the freezer unit 202 may be configured to be front-loading, wherein the tumbler 402, drum guard 408, and the drum tray 508 slide along the supporting slide rails 510 to access the tumbler 402 and easily to fill or refill the tumbler 402 with pre-cooked or frozen foods. This would be accessed by an operator by opening the door 120 of the automatic food cooking device 102, and subsequently opening the access panel 302 of the freezer unit 202.

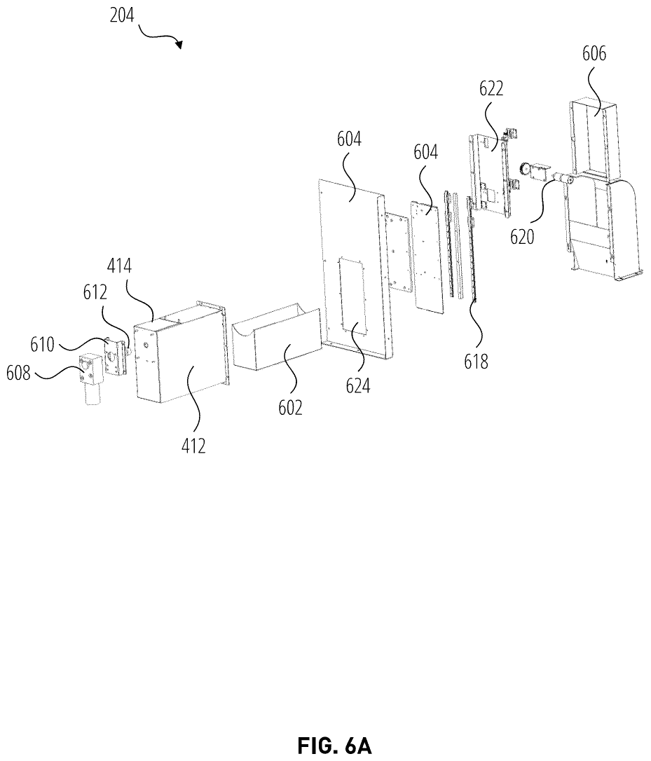

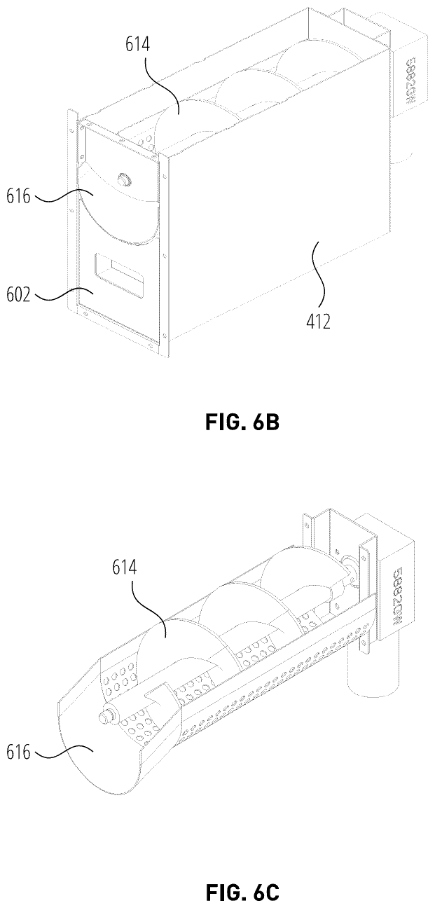

FIG. 6A illustrates an exploded view of a translation unit 204 of an automatic food cooking device 102, in accordance with one embodiment. The translation unit 204 mainly comprises a dispensing corkscrew module 412, but has a plurality of other components as well. As illustrated, these components include a motor mount 608, a motor bracket with coupling shaft 610 connected to a corkscrew motor 612, a dispensing corkscrew module 412 housing a corkscrew 614 and catch tray 602, a plurality of vertical panels 604, a vertical slide rail 618, corkscrew motor 612, sliding cover 622 and a translation unit cover 606. All the aforementioned components of the translation unit 204 are secured and operatively coupled together to ensure that a designated amount of food is translated from the freezer unit 202 to the weighing unit 206.

The dispensing corkscrew module 412 comprises a slot 414 configured to receive frozen food from the tumbler 402 of the freezer unit 202. The corkscrew blades of the corkscrew 614 (shown in FIG. 6B and FIG. 6C) housed within the dispensing corkscrew module 412 are welded into a stainless steel shaft powered by the corkscrew motor (e.g., DC motor or any motor known in the art). The corkscrew 614 is configured to rotate around an axis that is perpendicular to the rotational axis of the tumbler 402. By this mechanism, the corkscrew 614 conveys the frozen food from the rear end of the dispensing corkscrew module 412 to the front end of the dispensing corkscrew module 412. The catch tray 602 of the dispensing corkscrew module 412 is configured to catch any frozen food debris as they are translated through the corkscrew 614.

The vertical slide rail 618 is configured to be powered by a motor 620 to move a sliding cover 622 up once frozen food is released from the freezer unit 202, translated through the dispensing corkscrew module 412, and released through a vertical panel opening 624. The sliding cover 622 covers the vertical panel opening 624 once the designated amount of frozen food is weighed by the load cell 306. When there are no orders placed on the automatic food cooking device 102, the sliding cover 622 is at a position covering the vertical panel opening 624 as well.

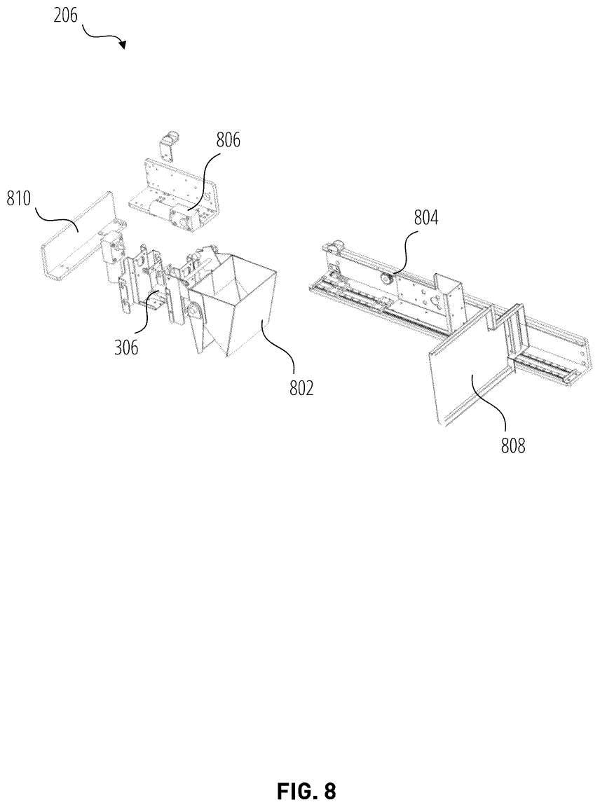

In some embodiments, the front end of the dispensing corkscrew module 412 may comprise a corkscrew outlet 616 that may be a tapered hole for frozen food to be extruded into a vertical channel covered by the translation unit cover 606. The vertical channel is configured to align with a receiving component of the weighing unit 206 (i.e., release claw shown in FIG. 8).

FIG. 7A illustrates an exploded view of a fry basket assembly of an automatic food cooking device 102, in accordance with one embodiment. The fry basket assembly comprises a fry basket 312, a fry basket plate 704, a connecting shaft 710, a dual shaft motor 706, a motor shaft sleeve 714, a fry basket motor base 708, and flip connectors 712 connected to the fry basket 312 via screws 702. The fry basket plate 704, connecting shaft 710 and dual shaft motor 706 may be secured to the fry basket using the flip connectors 712 and motor shaft sleeve 714. The fry basket motor base 708 is configured to house the dual shaft motor 706 configured to power the rotational motion of the fry basket 312 when engaged.

FIG. 8 illustrates an exploded view of a weighing unit 206 of an automatic food cooking device 102, in accordance with one embodiment. In a preferred embodiment, the weighing unit 206 comprises a release claw 802, a load cell 306, and a linear side rail 804. The weighing unit 206 may be configured to control the weight of frozen food received from the translation unit 204.

In terms of orientation, the load cell 306, equipped with the release claw 802, is mounted on a load cell connector plate 810, which is positioned toward the front end of the device 102. In contrast, the release claw 802 is oriented toward the rear end of the device 102. The load cell 306 is further connected to a load cell motor 806, which is mounted on a bracket secured on the linear side rail 804. In some embodiments, the linear side rail 804 is affixed on the internal surface of the left side face 112 of the device 102. In addition, the linear side rail 804 may comprise an oil baffle 808 which serves as a protective barrier against any oil splatters from the one or more fryers 310.

In some embodiments, the release claw 802 may comprise two jaws, wherein a first jaw serves as a main receptacle of frozen food and a second jaw serves as a supporting member. The release claw 802 may have a rotating spring linkage powered by a motor (e.g., DC motor) to open and close the jaws to control when the frozen food is released. The release claw 802 is further cantilevered at the end of a load cell 306 to determine the weight of the frozen food collected in it. The desired order weight may be predetermined depending on the amount of food that sufficiently fits into a cup 902.

Once the load cell 306 reads the desired order weight (which may be modified physically, at the machine, or remotely, via an administrative portal of a user interface), the release claw 802 306 is translated towards the rear end of the device 102 using a linear side rail 804 powered by a motor (e.g., DC motor). Otherwise, the freezer unit 202 and translation unit 204 continue to release frozen food to reach the desired order weight. The release claw 802 stops at a designated fryer 310 in the fryer unit 208. The position of the load cell 306 relative to the designated fryer 310 is controlled through a break beam. After ensuring that the release claw 802 is positioned above its designated fryer 310, the jaws of the release claw 802 open, dropping the frozen food into the designated fryer 310 filled with oil. Preferably, the position of the release claw 802 relative to the designated fryer 310 is optimized in order to minimize any oil splashes as frozen food is dropped.

Alternative embodiments of the release claw 802 mechanism may comprise flipping the food into the fryer 310 by the release claw 802. However, this is less desirable due to the increase in potential for splashing hot oil, posing safety and fire risks.

FIG. 9A and FIG. 9B respectively illustrate an exploded view and a perspective view of a cup dispensing unit 226 of an automatic food cooking device 102, in accordance with one embodiment. The cup dispensing unit 226 mainly comprises a cup dispenser 212, c-shaped cup holder 216, linear cup track 218, and vertical lift 314 mounted onto a motorized door 224. The cup dispensing unit 226 is configured to quickly and efficiently dispense empty cups 902 from the cup dispenser 212, position each empty cup 902 under the funnel 214 to receive cooked food, and deliver the cooked food to a user or customer via the exit port 118. Containers other than cups 902 known in the art may be alternatively used. In a preferred embodiment, the cup 902 or other container has an upper rim relatively larger than its bottom rim.

Once a user or customer places an order using the display screen 106, an empty cup 902 is dispensed from the cup dispenser 212 into a metal c-shaped cup holder 216. The c-shaped cup holder 216 is configured to support the cup 902 by its upper rim, providing positional stability without exerting clamping force, while the base of the cup 902 rests on an intermediate section of a linear cup track 218 located at the bottom end of the device 102. In some embodiments, the c-shaped cup holder 216 is mounted onto a support 918 powered by a motor 914 (e.g., DC motor). In some embodiments, the linear cup track 218 is mounted onto a linear cup track base 916, wherein the linear cup track 218 is oriented diagonally across the linear cup track base 916 with an angle between 30°-40° relative to the longitudinal axis of the linear cup track base 916. In a preferred embodiment, the linear cup track base 916 is made of a flat sheet for ease of maintenance.

The c-shaped cup holder 216 and support 918 may comprise one or more break beams to detect positional alignment at designated operational setpoints, including a cup drop setpoint, food dispensing setpoint, and vertical translation handoff setpoint. More specifically, the c-shaped cup holder 216 utilizes the one or more break beams to detect if an empty cup 902 has been successfully dropped into the holder 216, if cooked food is dispensed from the funnel 214 into the cup 902 held by the holder 216, and if the cup 902 held by the holder 216 is positioned at a designated interface between the linear cup track 218 and the vertical lift 314. The c-shaped cup holder 216 further acts as a means to prevent spilling of food during the transfer from the funnel 214 to the cup 902 when the cup 902 is positioned directly underneath the funnel 214, leaving a minimal gap.

In some embodiments, the motorized door 224 comprises a mounting bracket 908 for an internal exit enclosure (not shown) to prevent the user or customer from viewing the internal components of the device 102. The motorized door 224 further comprises a vertical lift 314 connected to a platform 910, wherein movement of vertical lift 314 comprises a linear slide rail driven by a vertical lift motor 912 (e.g., DC motor). A lifting module 906 is secured on the vertical lift 314, wherein the lifting module 906 comprises a flat cup base 904 to hold the cup 902 in place as the cup 902 is lifted and presented to the user or customer through the exit port 118.

The flat cup base 904 is configured to be elevated from the base of the lifting module 906, wherein the flat cup base 904 is connected to the base of the lifting module 906 through a side arm, leaving a space between the flat cup base 904 and the base of the lifting module 906. The configuration of the lifting module 906 is designed to avoid any collision with the c-shaped cup holder 216 during the cup handoff mechanism as described herein. In some embodiments, the flat cup base 904 is configured to be circular in shape with a diameter similar to that of the base of the cup 902, allowing the cup 902 to be displaced away from the c-shaped cup holder 216 since the c-shaped cup holder 216 has a larger diameter than the flat cup base 904. Furthermore, the c-shaped cup holder 216 is configured in such a way that the gap on the c-shaped cup holder 216 is configured to allow the side arm of the lifting module 906 to pass the holder 216 through the gap. Generally, the c-shaped cup holder 216 is specifically designed to translate through the flat cup base 904 by accommodating its shape, without the use of any additional actuators.

The mechanism of the cup dispensing unit 226 is triggered once a user or customer enters an order. The process begins with an empty cup 902 dispensed from the cup dispenser 212 and dropped into an intermediate section of the linear cup track 218. At this point, the empty cup 902 is supported at its upper rim by the c-shaped cup holder 216 to maintain positional stability.

Once the empty cup 902 is properly held by the c-shaped cup holder 216, the linear cup track 218 translates the empty cup 902 towards the rear end of the device 102, aligning it with the food dispensing setpoint underneath the funnel 214. Cooked food is then dispensed from the funnel 214 into the empty cup 902.

After the cup 902 is filled with cooked food, the filled cup 902 is translated towards the front end of the device 102, in particular, towards the vertical lift 314. The filled cup 902, still held by the c-shaped cup holder 216, is transferred onto the flat cup base 904 on the lifting module 906. Once the filled cup 902 is secured on the flat cup base 904, the vertical lift 314 is initiated to lift the lifting module 906, displacing the filled cup 902 beyond the c-shaped cup holder 216. When the c-shaped cup holder 216 is positioned within the space between the flat cup base 904 and the base of the lifting module 906, the vertical lift 314 pauses to allow for the c-shaped cup holder 216 to retract back into its initial position underneath the cup dispenser 212. Once the c-shaped cup holder 216 is retracted back past the lifting module 906, the lifting module 906 with the filled cup 902 resumes its upward motion towards the exit port 118.

The transition between the linear cup track 218 and the vertical lift 314 (i.e., cup handoff mechanism) is designed in such a way that incorporates one or more break beams to prevent any mechanical interference or collisions. Once the filled cup 902 reaches the top of the vertical lift 314, the cover of the exit port 118 may be opened by a linear slide rail driven by a DC motor, enabling the user or customer to retrieve the filled cup 902. In some embodiments, infrared sensors mounted on the sides of the vertical lift 314 may be configured to detect removal of the filled cup 902 from the exit port 118. After the filled cup 902 is removed, the system may accept a new order or automatically process a queued order.

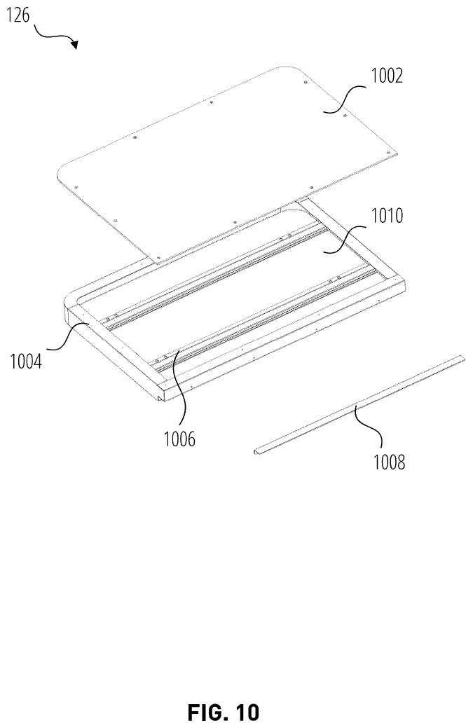

FIG. 10 illustrates an exploded view of an extended portion 126 of a front face 114 of an automatic food cooking device 102, in accordance with one embodiment. The extended portion 126 may be a signage comprising a signage cover 1002, a signage frame 1004, a lightbox stop plate 1008, and a signage back panel 1010. The signage cover 1002 may be configured to be translucent, allowing light to be diffused through it. The signage frame 1004 may house one or more lights 1006 such that the extended portion 126 may serve as a lightbox that displays a brand, logo or other offerings of the automatic food cooking device 102. The one or more lights 1006 may comprise LED bars or fluorescent bulbs. The signage back panel 1010 may be configured to be opaque. In some embodiments, the extended portion 126 is configured to generally have a rectangular shape but other shapes may be used as well.

Generally, for every movable component of the automatic food cooking device 102 is driven by at least one motor or actuator controlled by a circuit board hosting one or more break beams, one or more microcontrollers, wires, connectors, and other sensors. The one or more microcontrollers may be programmed to control a movement behavior of each of the movable components of the device 102, wherein the movement behavior may comprise a speed, direction, and timing at which the motor runs. The one or more microcontrollers may also be programmed to ensure operatively effective transitions between the plurality of components of the device 102.

An automatic food cooking device 102 may be linked to a user account on a web application and/or mobile device application, enabling users to monitor their position in the queue and receive real-time updates on their order status.

The web application or mobile device application may further comprise a plurality of interactive features for users, including, but not limited to: a reward system, gamification elements, RFID and NFC integration, order customization, and user profile personalization.

In terms of the reward system, users or customers may earn points by placing orders through the device 102. Accumulated points may be redeemed for free items or other exclusive offers. Gamification elements may involve having a premium subscription service offered to users or customers. Subscribers gain access to unique mission-based challenges to unlock rewards, coupons, merchandise and other incentives. Devices 102 may be equipped with RFID and NFC readers, allowing users to scan their merchandise or other application-linked items to receive exclusive offers and deals.

Furthermore, orders may be customized with sauces, condiments, seasonings and/or spices selected by users or customers. Having this feature involves a different embodiment than the one currently illustrated, wherein the device 102 is equipped with additional dispensers to apply the requested sauces, condiments, seasonings and/or spices to the cup filled with cooked food. In other embodiment, the additional dispensers may release the requested sauces, condiments, seasonings and/or spices in separate containers. Users or customers may further personalize their profiles via the web application or mobile device application, including the selection of color themes. These preferences may be reflected on the device 102 via smart LED lighting, creating a personalized experience for the users.

In some embodiments, the automatic food cooking device 102 may be equipped to handle more than one type of food. In one embodiment, the device 102 may incorporate one or more tumblers or other similar containers into the device 102, wherein the one or more tumblers may be paired with a designated fryer 310. As a result, the device 102 may be configured to serve multiple types of cooked food at the same time. In another embodiment, device 102 may include a recognition system designed to identify and selectively release a specific type of food for cooking, even when multiple frozen food types are stored together within a single tumbler.

In some embodiments, the automatic food cooking device 102 may further comprise a drink fountain or a bottled/canned drink dispenser for dispensing drinks to users or customers.

In some embodiments, the web application or mobile device application may further comprise an administrative portal, wherein each device 102 (associated with a unique code and its location) notifies an administrator or manager of relevant issues, including but not limited to, required maintenance, temperature fluctuations, required ordering, excess (not picked up) food, device being out of change, and the like.

In some embodiments, the web or mobile application may include an administrative portal that allows managers or administrators to monitor and manage each device 102. Each device 102 may be associated with a unique identifier and location, and may be capable of automatically notifying the administrator of relevant operational issues. These operational issues may include, but are not limited to: required maintenance, temperature fluctuations, inventory restocking needs, uncollected food items, low availability of change (i.e., bills or coins), and other system alerts.

Further aspects of the automatic food cooking device 102 may include: inventory management, electrical shock and fire prevention, and fryer safety. In terms of inventory management, the automatic food cooking device 102 may be connected to a backend server that allows inventory tracking, order notifications, and real-time device status monitoring. All food inventory within the device is assigned a software-defined expiry date, which automatically resets whenever new stock is added. If any item exceeds its expiry date, the system will block new orders until the expired inventory is replaced, and the expiry status is reset. Because the stored items are typically pre-cooked frozen foods (e.g., chicken nuggets, French fries, etc.) kept at below-freezing temperatures, the default shelf life is approximately six months. However, this duration can be customized based on the type of food or according to administrator-defined standards, allowing for shorter or longer expiry periods as needed.

The automatic food cooking device 102 may further have electrical shock and fire prevention measures. For instance, some embodiments of the device 102 may preferably comprise a plurality of independent breakers for the motors, freezer, and fryers, and a higher level leakage protection switch to automatically shut down the device 102 due to current spikes or electrical ground faults. While the one or more fryers do have an automatic shutoff feature, for emergency cases, the fryer unit is preferably equipped with a fire suppression device such as an automatic dry powder extinguisher that will activate at 170° C.

In terms of fryer safety, the one or more fryers may have dials to adjust fryer temperature with an automatic shutoff feature induced by high current draws. The automatic shutoff may occur if the oil level is too low or the burner unit exceeds the preset temperature. The one or more fryers 310 are isolated to the rear end of the device near exhaust fans to prevent any temperature buildup. The fryer unit 208 may further comprise a multi-layered activated carbon filter to capture any oil or odor particles.

Both clean and used oil containers are stored at the bottom end of the device 102 so that they are never lifted overhead. The device 102 can also accommodate extra oil tanks to simplify and speed up the oil refilling procedure.

The automatic food cooking device 102 may have one or more oil changing systems. Cooking oil may be manually or automatically dispensed into the one or more fryers 310 or drained from the one or more fryers. To pump out old oil, a manual hand-operated pump or an automatic pump may be used, which may be followed by a deep clean of the components of the fryer unit 208. The cleaning step may further be followed by refilling the one or more fryers 310 with clean oil. The oil changing system may start with having oil in a 10 L oil tank made of type 304 stainless steel, wherein the oil tank comprises a silicone tube extending from it.

In a manual operation, a user may choose to fill the one or more fryers 310 with clean oil, either by being notified by a maintenance alert, by the device 102 detecting when oil is low, or in need of changing, or during regularly scheduled maintenance of the device. The schedule maintenance of the device may be based on a predefined number of orders or a regular time interval. When the user presses an “add oil” button (either on a local device console or on a console remotely connected to the device), a diaphragm pump turns on and a solenoid opens. This allows oil to flow up the tube through the solenoid, and to the fryers by a spout. In some embodiments, each of the fryers is connected to a solenoid. In an alternative embodiment, the oil changing system may comprise a sensor which alerts the pump when the system is low in oil or empty after being cleaned. Upon being alerted, the pump may automatically flow clean oil into the fryers until the oil reaches a desired, predefined level in the fryer. In order to cycle used oil out, each fryer has a ball valve on the bottom of the fryer which may be opened. The ball valve may be accessible from the oil exchange unit 210 beneath the fryers 310. An operator may then press a “drain oil” button in the console (local or remote), which triggers a diaphragm pump to flush used oil from the fryers into a dirty oil tank stored within the oil exchange unit 210.

In an automatic operation, the one or more fryers 310 may comprise sensors to detect excess particulate matter or the like in the used oil in the fryers 310. If the amount of excess particular matter exceeds a predetermined threshold, the used oil in the one or more fryers 310 may be drained automatically. Alternatively, the one or more fryers 310 may be drained automatically at regular pre-set time intervals. The device may also be configured to automatically refill the one or more fryers after draining the used oil.

Preferably, the automatic food cooking device 102 is maintained at regular time intervals to maintain its performance, extend its lifespan, and lower operating costs. The device 102 may alert a user with administrative access when the device requires additional maintenance. Most of the components of the device 102 are removable, and accessible for managers having the keys or codes necessary to get inside the device 102. Maintenance processes for the device may comprise light maintenance steps or heavy maintenance steps.

In some embodiments, light maintenance steps may comprise setup steps, freezer unit 202 replenishing steps, oil draining steps, wipe down steps, oil refilling steps, cup replacement steps, and device restart steps. The setup steps involve an operator using access keys to unlock and open the one or more doors 120 of the device 102, including a front door at the front face 114 and maintenance panel at the back face 124 of the device 102. The access keys may be a physical key, a passcode or a mobile phone-based access point. The subsequent setup step involves turning off all breakers by flipping all switches off. The freezer unit 202 replenishing steps involve using a step stool and open a freezer door on at the top face 108 of the device 102 or open the access panel 302 of the freezer unit 202, unscrewing a plurality of hand pins on the hatch 404 to open the hatch 404 of the tumbler 402, taking bags of frozen food and dumping the frozen food into the tumbler 402 through the hatch 404 to refill it, screwing the plurality of hand pins on the hatch 404 to close the hatch 404 of the tumbler 402, and closing the freezer door or access panel 302.

The oil draining steps involve turning off an operator breaker, opening the maintenance panel at the back face 124 of the device, opening the fryer unit door 316, using a hand pump to pump oil out of the one or more fryers 310, and using hand screws to remove the fry baskets 312 from the fryer 310. The wipe down steps involve unscrewing four nuts to remove the funnel 214, using a dry paper towel to wipe down the funnel 214, fry baskets 312, and weighing unit 206, using a wet cloth and detergent to disinfect and clean the aforementioned components, and wiping down the aforementioned components with a dry cloth. The oil replenishing steps involve reinstalling the fry baskets 312 by screwing them back in place, turning on the operator switch at the breaker, pouring clean oil into each of the fryers until the clean oil is approximately 3 inches below the top of the fryer. The cup replacement steps involve removing plastic covering from three stacks of cups, wherein each stack has 50 cups, dropping all three stacks of cups into the cup dispenser 212 with the cups in an upright position, and visually inspecting to ensure that the cup stacks are properly aligned. The device restart steps comprise turning all breakers back on, closing the one or more doors 120 opened, and locking the one or more doors in place.

In some embodiments, the heavy maintenance steps include all the steps from light maintenance, along with additional steps for deeper cleaning. Generally, when it comes to heavy maintenance, all removable internal components of the device (e.g., fryers, fry baskets, tumblers, corkscrew, etc.) are completely removed, cleaned with detergent, and secured back in place within the device 102 after drying. All items are removable (and reconnectable) by simple hand-pins, hex keys, quick release latches, and the like. With respect to cleaning the corkscrew specifically, the steps are as follows: remove screws securing them on the dispensing corkscrew module 412, pull out the corkscrew, wipe down the corkscrew with a wet cloth and detergent to disinfect and clean it, wipe down the corkscrew with a dry cloth, and disinfect the corkscrew further once dried.

An additional embodiment of the oil changing system is described following drainage of oil out of the one or more fryers 310 according to the light maintenance instructions. A drain valve may be closed as a start, followed by removing a silicone tube connected to the used oil container, securing a cap to the opening of the used oil container, replacing the used oil container with a spare oil container, storing the used oil in another location, and filling the 10L oil tank with 2.5 gallons of clean oil.

In terms of maintaining the oil pump system driving oil exchange, an operator must perform the following steps in accordance with one embodiment: fill the clean oil tank with warm water and flush the system to remove as much residual oil as possible, perform the aforementioned step in relation to each of the one or more fryers 310, fill the clean oil tank with an alkaline solution, flush the oil pump system with the alkaline solution to clean the pumps, perform the aforementioned step in relation to each of the one or more fryers 310, fill the clean oil tank with warm water once more and flush the oil pump system to remove any residual alkaline solution. Other cleaning solutions such as alternative alkaline solutions, detergents, and sanitizers are commercially available and may be used to clean the oil pump system of the automatic food cooking device 102.

Overall, the disclosed devices, systems and methods provide an all-in-one unit wherein freshly cooked food can be efficiently prepared and delivered to customers or users, while optimizing serviceability and ease of use. Features such as having flat surfaces, mesh trays, catch trays, and the like further prevents buildup of food scraps and grime, promoting compliance with health and safety regulations and safe food handling practices. The disclosed device is also designed to reduce downtime from cleaning and maintenance.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Information as herein shown and described in detail is fully capable of attaining the above-described object of the present disclosure, the presently preferred embodiment of the present disclosure, and is, thus, representative of the subject matter which is broadly contemplated by the present disclosure.

What is claimed is:

1. A device for automatically cooking and serving food, the device comprising:
a freezer unit comprising a rotating tumbler configured to store the pre-cooked food and rotate about a first axis continuously;
a weighing unit configured to, upon the device receiving an order for food, receive pre-cooked food from the rotating tumbler;
a fryer unit comprising one or more fryers, each of the one or more fryers configured to receive the pre-cooked food in a rotatable fry basket from the weighing unit, wherein the rotatable fry basket is rotatable about a second axis that, at a first end of an axis of rotation, submerges the rotatable fry basket in the one or more fryers to prepare cooked food, and at a second end of the axis of rotation, flips the rotatable fry basket over a funnel; and
a cup dispensing unit configured to receive the cooked food from the funnel into a cup and transfer the cup filled with the cooked food to an exit port.

2. The device of claim 1, wherein the rotating tumbler is accessible via a front face of the freezer unit to load the rotating tumbler with the pre-cooked food.

3. The device of claim 2, wherein the rotating tumbler comprises:
a hatch configured to receive the pre-cooked food from a source external to the device; and
an exit hole configured to release a specific quantity of the pre-cooked food to the weighing unit.

4. The device of claim 3, wherein the exit hole comprises an adjustable guard, the adjustable guard being slidable along the exit hole for controlling the specific quantity of the pre-cooked food released from the rotating tumbler.

5. The device of claim 1, further comprising a translation unit housing a dispensing corkscrew configured to rotate about a third axis and transfer the pre-cooked food from the rotating tumbler to the weighing unit.

6. The device of claim 5, wherein the weighing unit further comprises:
a release claw configured to receive the pre-cooked food from the translation unit; and
a load cell configured to determine a measured weight of the pre-cooked food in the release claw and compare the measured weight with a predefined weight of the pre-cooked food, wherein the release claw and the load cell are operatively coupled.

7. The device of claim 6, wherein the release claw is configured to release the pre-cooked food into the fryer unit upon the load cell determining that the predefined weight of the pre-cooked food is reached.

8. The device of claim 1, wherein the one or more fryers comprise cooking oil and a temperature controller.

9. The device of claim 8, wherein the temperature controller is configured to:
keep the cooking oil at a standby temperature below a predefined cooking temperature while in a passive state; and
increase the standby temperature to meet the predefined cooking temperature while in an active state, the active state triggered upon the device receiving the order for food.

10. The device of claim 1, wherein the cup dispensing unit comprises:
a cup dispenser for holding a plurality of cups;
a cup holder configured for receiving the cup from the plurality of cups;
a first slide rail configured to translate the cup in a first direction to receive cooked food from the one or more fryers and subsequently translate the cup in a second direction;
a second slide rail configured to translate the cup in a third direction towards the exit port; and
a transfer interface between the first slide rail and the second slide rail, configured to translate the cup from the first slide rail to the second slide rail.

11. The device of claim 1, further comprising one or more pumps configured to facilitate oil exchange between one or more oil storage units and the one or more fryers.

12. A method for automatically cooking and serving food, the method comprising:
transferring pre-cooked food from a rotating tumbler in a freezer unit to a weighing unit upon receiving an order of food, wherein the rotating tumbler is configured to store the pre-cooked food and rotate about a first axis continuously;
transferring, via the weighing unit, the pre-cooked food received in the weighing unit from the rotating tumbler to a rotatable fry basket in each of the one or more fryers in a fryer unit, wherein the rotatable fry basket rotates about a second axis;
cooking, via the fryer unit, the pre-cooked food in the rotatable fry basket by submerging the rotatable fry basket in the one or more fryers at a first end of an axis of rotation;
transferring, via the fryer unit, cooked food from the one or more fryers to a funnel by flipping the rotatable fry basket over the funnel at a second end of the axis of rotation;
transferring, via a cup dispensing unit, the cooked food from the funnel to a cup; and
transferring, via the cup dispensing unit, the cup filled with the cooked food to an exit port.

13. The method of claim 12, further comprising accessing the rotating tumbler via a front face of the freezer unit to load the rotating tumbler with the pre-cooked food.

14. The method of claim 13, further comprising:
filling the rotating tumbler with the pre-cooked food from a source external to the device via a hatch on the rotating tumbler; and
releasing a specific quantity of the pre-cooked food from the rotating tumbler to the weighing unit via an exit hole on the rotating tumbler.

15. The method of claim 14, further comprising adjusting an adjustable guard along the exit hole for controlling a specific quantity of the pre-cooked food to be released from the rotating tumbler.

16. The method of claim 12, further comprising an intermediate step of transferring the pre-cooked food from the rotating tumbler to a translation unit before transferring the pre-cooked food from the translation unit to the weighing unit.

17. The method of claim 16, wherein the translation unit houses a dispensing corkscrew configured to rotate about a third axis and transfer the pre-cooked food from the freezer unit to the weighing unit.

18. The method of claim 17, further comprising:
receiving, via a release claw of the weighing unit, the pre-cooked food from the translation unit;
determining, via a load cell of the weighing unit, a measured weight of the pre-cooked food on the release claw, wherein the release claw and load cell are operatively coupled; and
comparing, via the load cell of the weighing unit, the measured weight with a predefined weight of the pre-cooked food.

19. The method of claim 18, further comprising releasing the pre-cooked food from the release claw to the one or more fryers upon the load cell determining that the predefined weight of the pre-cooked food is reached.

20. The method of claim 12, further comprising controlling, via a temperature controller on the frying unit, temperature of cooking oil within the one or more fryers, wherein the temperature controller is configured to:
keep the cooking oil at a standby temperature below a predefined cooking temperature while in a passive state; and
increase the standby temperature to meet the predefined cooking temperature while in an active state, the active state triggered upon the device receiving the order for food.
